(19) United States
(12) Patent Application Publication
(10) Pub. No.: US 2005/0242679 A1
(43) Pub. Date: Nov. 3, 2005

(54) Electromechanical power converter

(76) Inventors: Steffen Walter, Berlin (DE); Michael Georgi, Dresden (DE); Peter Hopf, Dresden (DE); Claus Bein, Dresden (DE)

Correspondence Address: NORRIS, MCLAUGHLIN & MARCUS, P.A., 875 THIRD AVE, 18TH FLOOR, NEW YORK, NY, 10022, US

(21) Appl. No.: 10/511,570

(22) PCT Filed: Apr. 9, 2003
(86) PCT No.: PCT/EP03/03701

§ 371 Date: Jun. 16, 2005

(30) Foreign Application Priority Data
Apr. 12, 2002 (DE) 102 17 285.4

(51) Int. Cl. H02K 1/00; H02K 3/00; H02K 21/00

(52) U.S. Cl. 310/181

(57) ABSTRACT

The miniaturization of electrodynamic converters causes and over-proportional reduction in power conversion density. The particular functional arrangement of the elements inside the power converter makes it possible to involve nearly the entire volume in the power conversion process. Flux concentration and multiple functions of different components permit and increase in the power conversion density in comparison to conventional miniaturizable converters. By rotating the toothed element wheel (9), an alternating magnetic flux from the permanent magnet elements (14) of the alternating axially polarized magnet ring (13) is conducted through the holed pin (1) via different magnet flux elements (21). Axially/radially oriented magnetic circuits (19) surround a flat coil (11) resting on the holed pin (1) and exert an induction action there. The power converter has a simple and robust design as well as a high power conversion density with regard to volume, and can be produced using conventional manufacturing techniques. In addition, very small sizes exhibiting a high power density can be realized.

Miniaturization of electrodynamic converters requires attention to specific aspects. The concepts and methods for producing larger electrical machines cannot be readily applied to machines having very small dimensions.

Frequently, air gap coils are used for miniaturized motors. The current conductors required for generating the forces are hereby arranged in the air gap between the flux-conducting elements of the magnetic circuits. U.S. Pat. No. 3,796,039; CH 570 648; JP 01-009372; DE 420595 C2; and DE 19902371 A1 describe examples for using air gap coils. Regardless if wire wound coils or coils produced by micro-mechanical methods are used, such coils disadvantageously require a relatively large air gap due to their spatial dimensions, which reduces the effective magnetic flux density and hence the power density of the energy converter. These types of converters require a complex manufacturing process, in particular with respect to the production of the coil arrangement.

Single-phase stepper motors have a simpler deign, in particular for miniaturized converters. U.S. Pat. No. 4,277,704 describes one such embodiment with an asymmetric configuration, which independent of the number of poles uses a single concentric coil which is placed on a one-piece laminated yoke. The flux through the permanent-magnet rotor is guided by pole nose portions. One disadvantage is poor volume utilization, low efficiency, and the difficulty of integrating the device in systems due to the shape of the energy converter. This type of electrodynamic converters is used in U.S. Pat. No. 6,120,177 as a drive for watches and as a generator for generating electric energy from mechanical motion energy.

The power density can be increased through flux concentration by soft-magnetic elements. DE 3135385 C2 describes an exemplary use of a laminated stator which forms pole arms and simultaneously reduces the effective air gap. The pole arms support coils. The rotor is configured as an external rotor and has a magnet ring which is polarized alternatingly in the radial direction with a cylindrical flux return. One disadvantage is the large moment of inertia. The distributed coils impede miniaturization and increase the manufacturing complexity.

Flux concentration and improved miniaturization are common in converters of the claw-pole type, as illustrated, for example, in DE 69613207 T2 and U.S. Pat. No. 4,644,246. These have alternatingly toothed stator yokes disposed about a ring coil, and a number of magnetized permanent magnets in the rotor, with the number of permanent magnets depending on the number of stator poles. Stator assemblies with a large number of poles can be implemented by using a single coil. The large stray flux between the alternatingly bent-over stator teeth reduces the power density and efficiency of such converters.

DE 2560231 C2 discloses a DC motor with an integrated tachometer generator for controlling the rotation speed. The tachometer generator includes a rotor, a soft-magnetic flux return element, a ring magnet, a ring coil in the flux return element, and a compensation coil outside the flux return element. The rotor of the tachometer generator is attached to the motor shaft and includes a soft-magnetic disk with teeth disposed along the circumference, a soft-magnetic bushing and a catch. The alternatingly radially magnetized ring magnet is embedded in the flux return element. Identically named poles of the magnet are arranged in radial opposition to the rotor teeth. The magnetic flux which changes during the rotation is chained with the measurement coil and induces in the measurement coil a voltage proportional to the rotation speed. The flux is guided from the ring magnet via the flux return element, via an internal radial air gap to the bushing, via the toothed disk and via an outer radial air gap back to the magnet. The air gaps have to be quite large because of potential installation tolerances of the selected configuration. The radial air gap on the bushing prevents miniaturization of the design. The integration of an independent rotor support also becomes more difficult. Moreover, the miniaturization can significantly increase the stray flux, and the simultaneous action of the magnetic forces on all teeth due to the miniaturization can produce a significant latching torque. Because the output power of tachometer generators is intentionally quite small and sufficient design space is available, assemblies according to DE 2560231 C2 can be readily employed.

All the aforedescribed examples have only limited applicability for realizing small design sizes with a high-power density.

It is an object of the invention to provide an electromechanical energy converter with a stationary assembly and a high torque for energy conversion, which provides a high energy conversion density already at a low rotation speed, which has a simple and robust construction, and which can be easily manufactured in small sizes.

The object of the invention is solved by an electromechanical energy converter according to claim 1.

The invention relates to an energy converter which is suitable for converting mechanical energy into electrical energy as well as for converting electrical energy into mechanical energy, wherein the mechanical energy exchange to the environment is accomplished via a rotor according to claim 1 and the electric energy exchange to the environmental is accomplished via the terminals of a flat coil according to claim 1.

The magnetic flux change necessary for energy conversion in the energy converter of claim 1 and the cooperation with a coil follows essentially the principle established in DE 2560231 C2. However, the design of an energy converter according to claim 1 is has a considerably more versatile design, is considerably more compact, smaller, and has a significantly higher performance and can be implemented as a stand-alone device. Important, in particular for miniaturization, are the design particulars in the regions of the energy converter near the center and in the axially adjoining regions. Accordingly, a core zone according to claim 1 is defined as the space, which is included in the axial projection of the inside diameter of the flat coil.

In the context of this application, a flat coil is to be understood as a coil where the ratio of coil height to outer diameter of the coil is less than 1. Advantageously, with the stationary arrangement of the flat coil according to claim 1, the flat coil can be contacted by a fixed wiring arrangement, thus obviating the need for a brush assembly. The concentric arrangement about the rotation axis of the rotor, which simultaneously represents a system axis for the energy converter, and the design as a flat coil result in a rotationally symmetric, preferably flat and space-efficient design of the energy converter.

The magnetic flux element and permanent magnet elements arranged about the flat coil according to claim 1 completely surround the flat coil except for functionally required air gaps, whereby the term “air gap” used herein generally refers to a magnetically inactive space and therefore also includes regions that are filled with non-magnetic solids. The air gaps are always arranged concentrically about the rotation axis of the energy converter and will therefore be referred to as annular air gaps. With complete pole coverage, the magnetic flux elements form axially-radially oriented magnetic circuits. The field lines emanating from magnetic poles having the same pole designation then extend in a closed axial-radial path about and through the flat coil, i.e., on the end faces in a radial direction, and outside and through the center in an axial direction, thereby completely surrounding all coil windings.

Advantageously, with the electromechanical converter according to claim 1, in addition to the flat coil, the permanent magnet elements are also stationary and arranged with rotation symmetry to form a magnet ring. The permanent magnet elements of the magnet ring can consist of individual permanent magnets or of permanent magnets which have on one side or on both sides pole shoes made of a soft-magnetic material. Advantageously, the magnet ring can also be made of a single piece—for example, as a pressed, injection-molded or sintered ring, which can then be magnetized in sectors with alternating pole orientation. The axial, radial or axial-radial pole orientation, when arranged between other soft-magnetic flux elements, supports the axial-radial path of the field lines desired in the energy converter around and through the flat coil. On the other hand, such field line path can be readily achieved with completely through-magnetized permanent magnets, i.e., magnets which are magnetized through the entire volume from one surface to the other surface. Accordingly, very short field line paths can be realized with this design of the permanent magnets, as well as a high volume efficiency and material utilization of the permanent magnets.

The energy converter of claim 1 includes magnetic flux elements which are implemented as toothed elements and which form a soft-magnetic toothed element ring, which is rotationally symmetric and concentrically arranged relative to the rotation axis of the rotor. This toothed element ring is also a component of the rotor.

So called toothed element gaps, i.e., regions without the soft-magnetic material, are disposed between the toothed elements. The magnet ring and the toothed element ring are arranged coaxially and separated from each other only by a narrow annular air gap. Depending on the position of the toothed elements, the field lines emanating from the permanent magnets, aside from unavoidable parasitic magnetic flux returns caused by the design, close essentially via two paths. A short path runs via toothed elements, adjacent permanent magnet elements and from there via magnetic flux elements acting as flux return. In addition, a long path exists via the large axially-radially oriented magnet circuits, which extend via the toothed elements and additional magnetic flux elements through the center of the flat coil. The toothed element gaps are important for guiding the magnetic flux via the toothed elements through the coil center and to prevent premature return flux. The requirement for sufficiently large toothed element gaps is one of the major obstacles preventing miniaturization. Only field lines which are guided around the coil in an axially-radially oriented magnet circuit are relevant for an effective electromagnetic coupling of permanent magnets and flat coil and hence for energy conversion. If a toothed element directly faces a permanent magnet element, then the magnetic flux via the long path, i.e., in the axially-radially oriented magnetic circuit through the flat coil is maximal. Conversely, if a toothed element is located between two permanent magnet elements, then the short path is maximally utilized and the flux through the flat coil is zero.

The flux in a magnetic circuit depends on the shape of the magnetic circuit, i.e., also on the relative position of its magnetic flux elements and is connected in the event of a changing reluctance with a corresponding force between the magnetic flux elements. By arranging the toothed element ring according to claim 1 so as to be connected with the rotor and therefore movable, the flux in the large axially-radially oriented magnetic circuits extending through the flat coil can be changed by rotating the rotor, which makes it practical to convert mechanical energy via magnetic energy into electric energy and vice versa. If the number of the toothed elements is identical to that of the pole pairs of the magnet ring, if the toothed elements and the permanent magnet elements are uniformly distributed about the circumference, then the axially-radially oriented magnet circuits always have a maximal total flux in the same direction if the toothed elements and the permanent magnet elements have a frontal position. Accordingly, a maximal magnetic flux of all permanent magnets can alternatingly be conducted through the flat coil during rotation, first with one pole orientation and then with the other pole orientation. Movement of the rotor then produces maximal gradients in the magnetic flux change through the flat coil for mechanical-electrical energy conversion. For an electromechanical energy conversion, the combined flux of the coil causes a field displacement and therefore a torque on the rotor.

The annular air gap between the magnet ring and the toothed elements according to claim 1 can be arranged very tightly because of the radial, axial or axial-radial arrangement. This results in very advantageous operating points for the permanent magnets, thus satisfying an important prerequisite for effective energy conversion at low rotation speeds.

The different preferred path of the magnetic field lines, which depends on the relative position of the toothed element to the permanent magnet element, i.e., via the short path or via the long axial-radial path, causes a latching torque in corresponding rotor positions. The width and shape of the toothed element can be optimized so that the corresponding forces have an opposing effect on a torque and thereby affect, i.e., minimize, the individual latching torques as well as the total latching torque. In particular, the latching torques as well as possibly also the stray flux can be reduced by providing the toothed elements with a curved shape, such as a sickle shape.

It is advantageous for the efficiency of the energy converter if the core zone is as small as possible, i.e., the flat coil has the smallest possible inside diameter for receiving a large number of low-resistance windings. Moreover, the magnet ring should have the greatest possible inside diameter for accommodating the largest possible effective magnet cross-section, and for also realizing a large pole number, for achieving a high circumferential velocity at the circumference of the rotor to effect large magnetic flux changes, and for minimizing parasitic magnetic return flux due to the limited space. In addition, for a large distance between the core zone and the peripheral annular air gap, the gaps between the toothed elements can be larger or extend deeper toward the center to minimize magnetic stray flux. According to claim 1, a large outside diameter of the magnet ring can be easily realized by arranging the annular air gap between the toothed element ring and the magnet ring in a peripheral region outside the core zone. This applies also to other energy converters, for example the tachometer generator disclosed in DE 2560231 C2.

Advantageously, claim 1 also makes it possible to realize flat coils with a small inside diameter. Generally, at least two annular air gaps are required for energy converters of the aforedescribed type, so that a rotor can move freely in the stationary section of the energy converter. Claim 1 allows the following two basic design alternatives: a core zone with an annular air gap, or a core zone without an annular air gap. In the first case, both annular air gaps are arranged outside the core zone and a corresponding magnetic flux element which is part of the rotor disk encloses the flat coil from the interior through the core zone. The diameter of this magnetic flux element can be minimized s that the magnetic flux remains below saturation. The inside diameter of a flat coil can be designed accordingly. In the second case, a discontinuity, namely the annular air gap, is located in the core zone between rotor and stationary magnetic flux elements. In this case, the rotor must be guided or supported in addition to the magnetic flux. If several annular air gaps are located in the core zone, then according to claim 1, at least one annular air gap must be arranged axially between the rotor disk and a stationary magnetic flux element. The annular air gap can also be a separately constructed section of a larger annular air gap consisting, for example, of a radial section and an axial section. This axial annular air gap can directly conduct the magnetic flux between the rotor disk and the stationary magnetic flux element. This occurs exclusively in a region outside the rotor shaft when using a non-magnetic rotor shaft. Because the cross-sectional area of a conventional rotor shaft is small compared to the area of the air gap between the rotor and the stationary magnetic flux element, the magnetic flux would be preferably conducted via the axial annular air gap and not via the existing design-related radial annular air gap, oven with soft-magnetic rotor shafts. A bearing according to claim 2 can be easily integrated in the design by employing the axial annular air gap. Combining the magnetic flux conduction with the bearing function results in a space-saving design, which is important for miniaturization. Axial annular air gaps generally offer optimal choices for selecting materials and design dimensions, so that all support, guiding and magnetic flux functionalities can be realized within the core zone and the core zone itself can be minimized. This enables flat coils with a small inside diameter and therefore a high energy conversion density. A bearing that fills additional space is not yet integrated in DE 25 60 231 C1, and the field lines are guided preferably or exclusively by a radial air gap disposed between the rotor and the stationary magnetic flux elements. Magnetic saturation can easily occur for the small rotor shaft diameters necessitated by miniaturized designs. This shortcoming can only be overcome with a relatively strong rotor shaft, which has disadvantages for the operating characteristics, or with an initially reduced magnetic field energy, which has disadvantages for the energy conversion density. In addition, bearing support has to be provided as well as a sufficiently large air gap area for an adequate magnetic flux. The latter is possible only with a correspondingly large rotor shaft diameter and also a long radial annular air gap. This uses up more space and causes a larger friction torque due to the large bearing surfaces, if the bearing of the rotor is integrated in the converter. A radial air gap design, which implements these bearing and magnetic flux functionalities, requires more space in the core zone than an axial air gap design. Coils with a radial air gap design therefore have a larger inside diameter and a smaller power density and efficiency. An energy converter with a radial annular air gap in the core zone is hence not amenable to miniaturization. An axial annular air gap in the core zone according to claim 1 is more compatible with a flat energy converter, both constructively and functionally, than a radial annular air gap, and better takes advantage of a flat design for a high energy conversion density. Axial annular air gaps for energy converters with an annular air gap in the core zone or a design which moves air gaps away from the core zone enable a more compact design with a smaller core zone diameter, which results in higher power densities even when the energy converters are miniaturized. This is a particular advantage over energy converters with a radial annular air gap, such as the tachometer generator described in DE 25 60 231 C1. The latter is primarily intended for measurement tasks, where high power densities are secondary and the tachometer generator arrangement can be supported via the motor shaft.

Another significant increase in the efficiency can be achieved with an arrangement according to claim 3. Magnetic flux and bearing functions can advantageously be combined by arranging a layer of a hard material between the soft-magnetic parts of the rotor and the stationary magnetic flux element which supports the rotor. Advantageously, a friction layer made of a hard material is arranged in the region of the axial annular air gap. Because sliding layers made of a hard material have layer thicknesses of only several micrometers or less, very narrow annular air gaps can be realized, so that the axially-radially oriented magnetic circuits are only insignificantly attenuated at that location. The sliding layer made of the hard material can be applied on the rotor side, on the stationary magnetic flux element, or on both bearing sides. Advantageously, the hard material for the friction layer can be carbon in the form of diamond or with a lattice structures similar to that diamond, which can be deposited, for example, from the gas phase by a PVD process. The bearing should not only have a low friction coefficient, but also a low wear rate and high temperature stability. Advantageous is also a hard layer made of iron, for example, by embedding foreign atoms or through another change in the atomic iron lattice structure, which can produce a zero air gap. Overall, a bearing design according to claim 3 significantly increases the efficiency compared to other solutions that form additional air gaps. Advantageously, the energy converter is also simple, robust, reliable, and has a small size.

The efficiency can be further improved by constructing the flat coils according to claim 4. A very high fill factor of the coil winding can be achieved with helical coils arranged in a single plane and by using metal tape as the conducting material, which is particularly effective with flat coils. Suitably wound flat coils have a higher mechanical stability compared to coils wound with round wire, are easier to install, have a higher inductance with a smaller ohmic resistance, and realize a higher energy conversion per unit volume with lower losses.

Energy converters according to claims 1 to 4 can be easily and advantageously upgraded or combined. For example, according to claim 5, a rotor or certain rotor regions can be utilized by two energy converter units constructed according to claim 1 to 4. This can advantageously result in less material-consumption, improved compensation of magnetic forces or reduction of the bearing forces as well as improved operation of the energy converters.

With a suitable design of the toothed elements, energy converters according to claim 6 can be operated as self-starting synchronous motors. The preferred rotation direction can be defined, for example, by forming bevels or sickle-shaped projections on the toothed element heads. The energy converter can be designed and the flat coil can be controlled so as to provide a motor function with a single energy converter according to claim 6. However, the rotation direction can be better controlled by using two energy converters coupled via the rotors, which also improves and simplifies the control, start-up and running characteristics. The two energy converters can be coupled either by axially connecting the two energy converters according to claim 5 or by a forced coupling, for example a gear mechanism, according to claim 7. Finally, coupling of the energy converters can also affect the total latching torque, which can potentially be reduced by the design of the energy converter recited in claims 1 to 7.

Energy converters according to claims 1 to 7 are simple, robust, reliable and cost-effective. Nearly all components of electromechanical energy converter according to claims 1 to 7 can be a part of the energy conversion process, while stationary magnetic flux elements can also perform other functionalities, such as bearing or housing functionalitics. Because of this and the basic design of claim 1, the energy converter has a high energy conversion density per unit volume. The energy converter can be manufactured using conventional manufacturing techniques, and even small devices with a high power density can be readily realized.

The invention will be described hereinafter in more detail with reference to an embodiment.

The drawings show in:

FIG. 1 an energy converter with axially oriented permanent magnet elements;

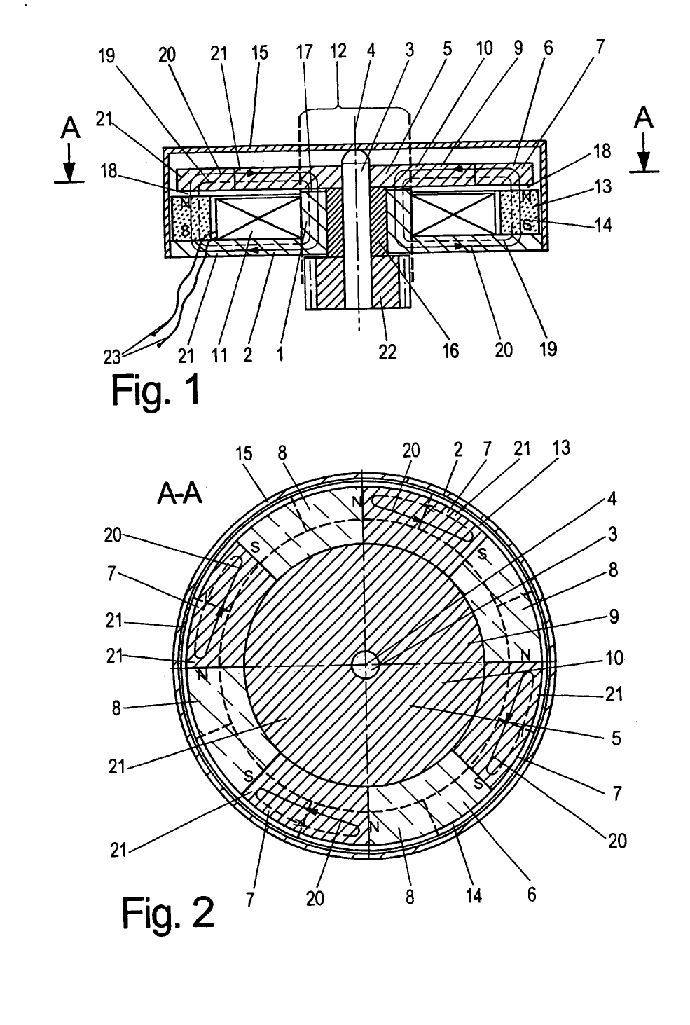

FIG. 2 a cross-section of the energy converter of FIG. 1 taken along the line A-A;

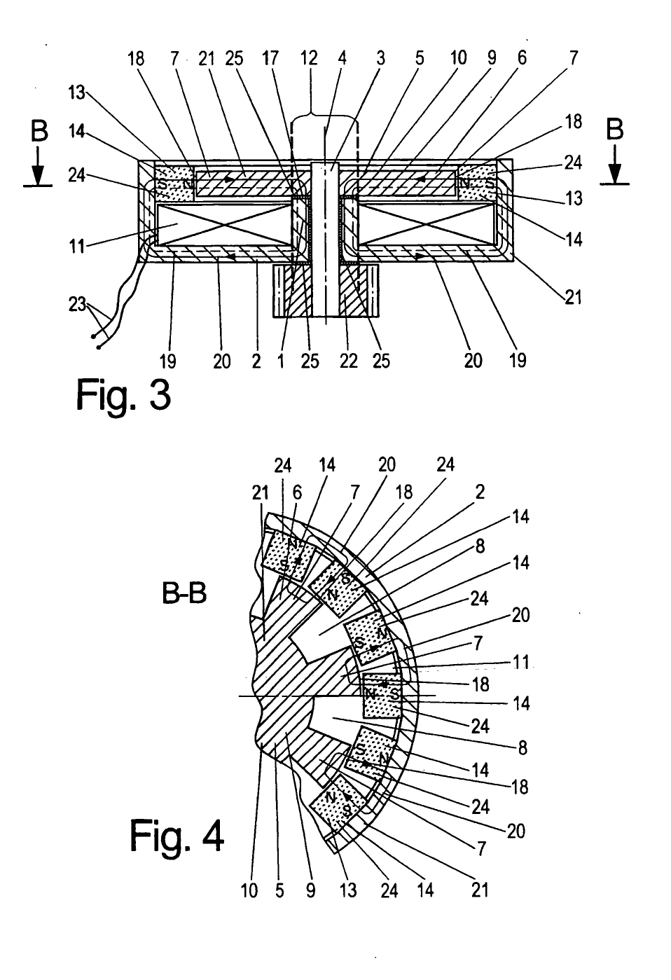

FIG. 3 an energy converter with radially oriented permanent magnet elements;

FIG. 4 a cross-section of the energy converter of FIG. 3 taken along the line B-B (detail);

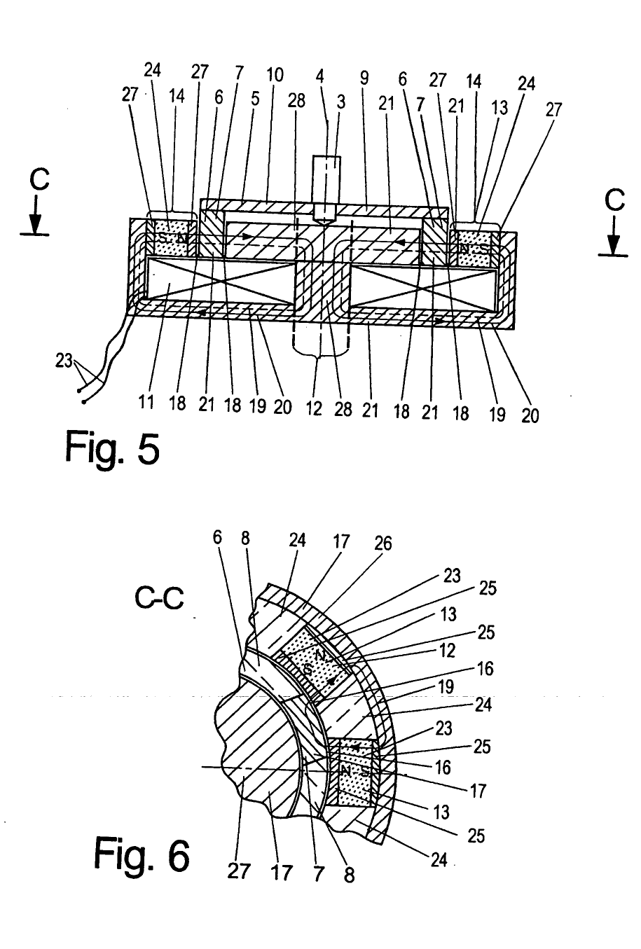

FIG. 5 an energy converter with radially oriented permanent magnet elements and pole shoes;

FIG. 6 a cross-section of the energy converter of FIG. 5 taken along the line C-C (detail);

FIG. 7 an energy converter with curved permanent magnet elements;

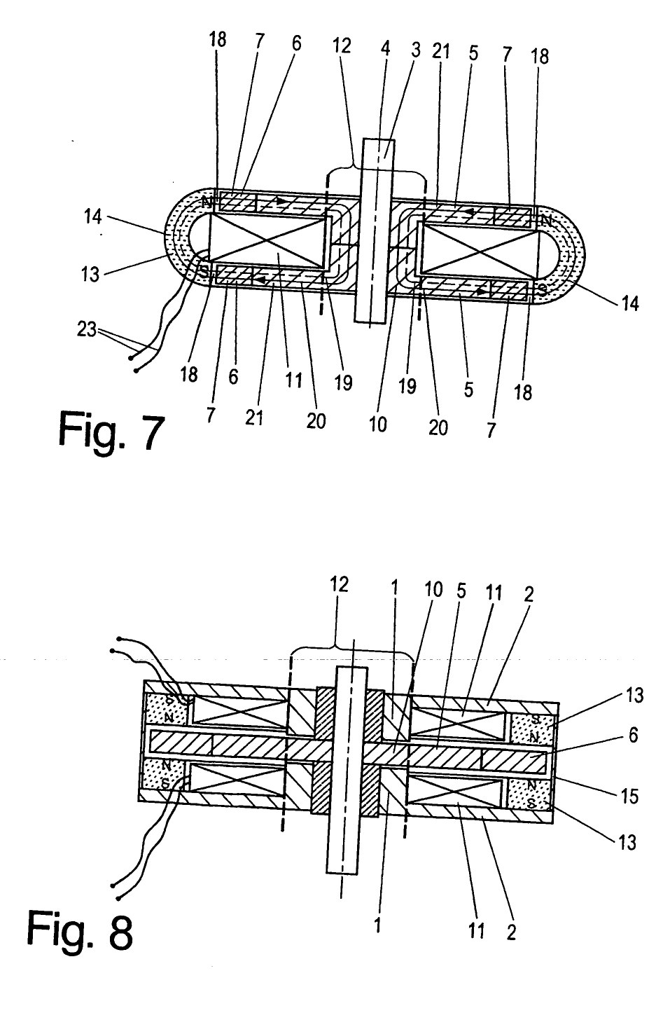

FIG. 8 energy converters, coupled via a common rotor;

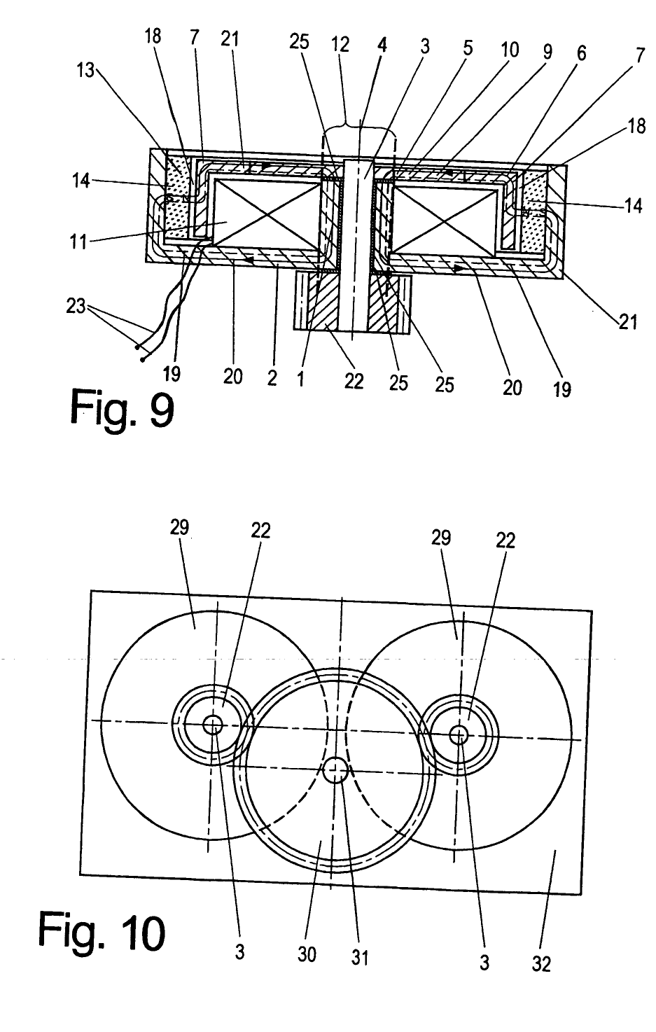

FIG. 9 an energy converter with a basket-shaped toothed element wheel;

FIG. 10 an energy converter, with a geared coupling; and

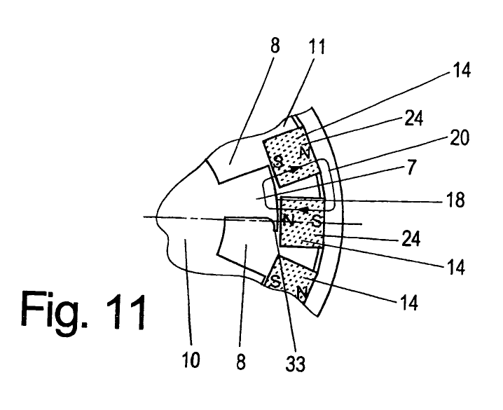

FIG. 11 a top view of the energy converter of FIG. 3 with sickle-shaped extensions on the toothed elements (detail).

As shown in FIG. 1, the electromechanical energy converter according to claim 1 includes a rotor shaft 3 made of polished sapphire, which is disposed in a center holed pin 1 of a punched disk 2 so as to be freely rotatable about its rotation axis 4. A rotor disk 5 is made of silicon iron and fixedly connected with the rotor shaft 3. A toothed element ring 6 is securely mounted on the outer periphery of the rotor disk 5. The toothed element ring 6 is constructed of four respective ring sectors made of a metal-metal-composite, such as silicon iron and brass. The iron ring sectors form the toothed elements 7 and the brass ring sectors form four toothed element gaps 8 according to claim 1. Since there is no gap between the soft-magnetic rotor disk 5 and the soft-magnetic toothed elements 7 of the toothed element ring 6, the rotor disk 5 and the toothed element ring 6 form constructively and magnetically a unit, referred to as a toothed element wheel 9. The toothed element wheel 9 and the shaft 3 form a rotor 10. A flat coil 11 is placed directly around the holed pin 1 between the disk-shaped portion of the punched disk 2 and the toothed element wheel 9. The core zone 12 of the energy converter is indicated by two dashed boundary lines and is by definition according to claim 1 bounded by the inside diameter of the flat coil 11. A magnet ring 13 made of the magnetic material neodymium-iron-boron embedded in plastic is arranged very tightly about this flat coil 11, also between the disk-shaped portion of the punched disk 2 and the toothed element wheel 9. The magnet ring 13 is magnetized axially in alternating directions and can therefore be viewed as consisting of eight individual permanent magnet elements 14. The flat coil 11 and the magnet ring 13 are firmly glued to the punched disk 2. A housing enclosure 15 is tightly placed on the periphery of the punched disk 2 and secured with an adhesive, thereby also sealing off the entire arrangement on the backside of the toothed element wheel 9 and protecting it from outside contamination. The interior center of the front face of the housing enclosure 15 also functions as an additional axial bearing for the rotor shaft 3. A sliding bearing 16, consisting of sintered bronze and operating as a radial and axial bearing, is disposed inside the holed pin 1. All parts are arranged rotationally symmetric about the rotation axis 4, which represents also a system axis for the entire electromechanical energy converter. The protruding, magnetically inactive sliding bearing 16 forms on the font side of the punched disk 2 between the rotor disk 5 and the holed pin 1 an axial annular air gap 17 of approximately 0.05 mm, which transmits practically the entire magnetic flux in the core zone 12. Separation of the bearing and magnetic flux function in the core zone 12 guarantees, on one hand, a reliable bearing operation and, on the other hand, a well defined and reproducible magnetic flux in the core zone 12. An additional 0.1 mm wide annular air gap 18 is disposed between the toothed elements 7 and the magnet ring 13. The punched disk 2, the permanent magnet elements 14, the toothed element wheel 9 as well as the annular air gaps 17 and 18 form, when the toothed elements 7 and permanent magnet elements 14 are in a frontal position, the axially-radially oriented magnetic circuits 19 with magnetic field lines 20 that extend tightly around or through the flat coil 11 in an axial-radial direction. The annular air gaps 17 and 18 represent magnetic resistances in the axial-radial oriented magnetic circuits 19, which is necessary to ensure the function of the electromagnetic converter according to claim 1. When the rotor 10 rotates, all toothed elements 7 move past the permanent magnet elements 14 of one pole orientation and then past the permanent magnet elements 14 of the opposite pole orientation. FIG. 1 illustrates a situation where the permanent magnet elements 14 and the toothed elements 7 are positioned so as to directly face each other. The preferred path of the magnetic field lines 20 extends via the long paths along the axially-radially oriented magnetic circuits 19 with substantially separate axial-radial field line paths for each permanent magnet element 14 around and through the flat coil 11.

FIG. 2 is a top view of the same energy converter as FIG. 1. However, FIG. 2 shows the intermediate position of toothed elements 7 relative to the permanent magnet elements 14, where the magnetic field lines 20 are closed preferably by the short path via the toothed elements 7 to the corresponding adjacent permanent magnet element 14 and from there via a rearward magnetic flux element 21, in this case the punched disk 2, back to the original permanent magnet element 14. The mechanical energy is transmitted to the environment via the pinion 22, whereas the electrical energy is transmitted via two wire ends 23 of the coil.

The magnetic field lines 20 in the energy converters of FIGS. 1 and 2 pass through the annular air gap 18 between the magnet ring 13 and the toothed element ring 6 in the axial direction. A, different energy converter according to claim 1 is shown in FIG. 3, where the permanent magnet elements 14 are arranged so that the magnetic field lines 20 emerge in the radial direction and reach the toothed element ring 6 via the annual air gap 18. The magnet ring 13 is composed of individual permanent magnet elements 14 in the form of small cuboids which are glued directly on the interior wall of a cup-shaped punched disk 2 with a spacing of half the width of a cuboid. The permanent magnet elements 14 are made of the Samarium-Cobalt cuboids and represent individual magnets 24. The toothed element gaps in the embodiment of FIG. 3 are directly milled into the soft-magnetic rotor disk 5 and consequently are composed of air. The toothed elements 7 are formed simultaneously, so that the toothed element ring 6 and the rotor disk form a unitary component. According to FIG. 3, a several micrometer thick sliding layer 25 made of a hard material is applied to the holed pin 1 of the punched disk 2. The sliding layer 25 is applied on both sides of the end faces and also inside the holed pin 1. The spacing between the toothed element wheel 9 and the pinion 22, which are both fixedly secured on the rotor shaft 3, are only approximately 5 μm greater than the length of the holed pin 1, including the hard coating. An identical spacing exists between the rotor shaft 3 and the interior hole in the holed pin J. This arrangement provides a very stable axial and radial sliding bearing, as well as an axial annular air gap 17 of less than 10 μm. The axially-radially oriented magnetic circuits 19 are then only slightly weakened at this location by a very small magnetic resistance. The arrangement illustrated in FIG. 3 has the advantage that the flat coil 11 can fill the entire region between the toothed element wheel 9 and the punched disk 2, while due to its radial position, a very narrow annular air gap 18 between the permanent magnet elements 14 and the toothed elements 7 can be designed and fabricated. The core zone 12 can also have a very small diameter, because the holed pin 1 can be used effectively both as a magnetic flux element 21 and as an element for the sliding bearing. Because the holed pin 1 has three times the diameter of the rotor shaft 3, which corresponds nine times the area, a radial air gap in the core zone 12 would likewise have less of an effect on magnetic flux guiding when a soft-magnetic magnetic shaft 3 is used. For increasing the inductance, the flat coil 111 in the arrangement of FIG. 3, corresponding to claim 4, is made of a helical coil wound in a single plane, wherein a varnish-coated metal band with dimensions 1.2×0.02 mm is used as coil material.

FIG. 4 shows a top view of the arrangement of FIG. 3, with the toothed elements 7 and permanent magnetic elements 14 shown in the intermediate position, like in FIG. 2. The energy converters of FIGS. 1-4 have a diameter of 12 mm and a height of 3 mm.

FIG. 5 shows an energy converter with a magnetic pole orientation similar to that of FIGS. 3 and 4, except that both functionally required annular gaps 16 are located outside the core zone 12, and no annular gap 16 is located inside the core zone 12. The magnet ring 13 is made here of a composite of brass segments 26 and separated soft iron segments, with individual magnets 24 arranged between the soft iron segments. The soft iron segments represent pole shoes 27 for the individual magnets 24 and form in conjunction with the individual magnets 24 the permanent magnet elements 14. The toothed element ring 6 is composed of an assembly of the elements 7 made of soft iron and toothed element gaps 8 made of brass. The toothed element ring 6 is welded on a rotor disk 5 made of brass to form a cup-shaped assembly. The flat coil 11 is almost completely surrounded by a soft magnetic, two-part coil core 28, which represents a stationary magnetic-flux element 21. The magnet ring 13 and the toothed element ring 6 engaging from above are located in the opening of flux element 21. In this arrangement, the two radial annular air gaps 16 are located between the toothed elements 7 and the magnet ring 13 and also between the toothed elements 7 and the coil core 28. Because the coil core 28, the toothed element ring 6 and the magnet ring 13 can be manufactured as turned parts, very narrow, several μm wide radial annular air gaps can be realized. This is not possible with the arrangement of FIGS. 3 and 4 due to the planar design of the individual magnets 24.

FIG. 6 shows a top view and an intermediate position of the arrangement of FIG. 5, where the magnetic field lines 20 are closed along the short path.

FIG. 7 shows another arrangement, where only the annular gaps 16 are located outside the core zone 12. In addition, curved permanent magnet elements 14 are used, which are magnetized along their curved section and are combined to a magnet ring 13 with alternating pole sequence. With the magnetization extending along the curved section, both a magnetic North Pole and magnetic South Pole projects in the radial direction towards the center of the energy converter at different axial positions. Two soft magnetic rotor disks 5 are pressed onto a rotor shaft 3 in abutting relationship and together form the rotor 10. A toothed element ring 6 is machined out of the rotor disks 5, like in FIGS. 3 and 4. A free space for the self-supporting flat coil 11 which is glued to the magnet ring 13 is provided inside the rotor 10. The curved permanent magnetic elements 14 and rotor disks 5 form the axially-radially oriented magnetic circuits 19 which according to claim 1 enclose the flat coil 11 through its coil center. Very small radial annular air gaps 16 can likewise be set with the arrangement of FIG. 7.

FIG. 8 shows an arrangement according to claim 5, wherein two energy converters similar to those of FIGS. 1 and 2 have a common rotor 10 with a common toothed element ring 6 and a common rotor disk 5. This arrangement has to advantage that in particular axial forces can be compensated.

The energy converter in FIG. 9 corresponds to the energy converter in FIG. 3, except that the toothed elements 7 are here angled with respect to the rotor disk 5. The toothed element wheel 9 is then in the shape of a basket, with the permanent magnet elements 14 and the toothed elements 7 being able to face each other along the annular air gap 18 over a larger area. Such an arrangement also results in a high energy conversion density, when permanent magnetic materials with a low residual induction are used, such as permanent magnets in a plastic binder.

FIG. 10 shows a geared drive according to claim 5 between two energy converters 9 of the type depicted In FIGS. 3 and 4, which are coupled via a coupling gearwheel 30. The rotational and hence also the mechanical energy are transmitted by the coupling gearwheel 30 via a driveshaft 31 to the outside. Both energy converters are received in a common housing 32 which also supports the driveshaft 31. By arranging the toothed elements 7 in one energy converter 29 so as to face the permanent magnets 14 directly, whereas the toothed elements 7 and the permanent magnetic elements 14 in the other energy converter 29 assume an intermediate position, the motor can operate with a controlled rotation direction by sending a current alternatingly through the respective flat coils 11 of the energy converters 29.

FIG. 11 shows an alternative exemplary embodiment of the toothed elements 7 depicted in FIG. 3 for defining the start-up direction of the energy converter in motor operation. The different magnetic saturation in the sickle-shaped projection 33 under different current flows through the flat coil 11 defines the start-up direction. Alternatively, following the same principle, the start-up direction can also be defined by differently shaped, asymmetric chamfers, steps or segments in form of spiral sections.

1. Electromechanical energy converter with a rotor (10), wherein
a stationary flat coil (11) is arranged concentrically about the rotation axis (4) of the rotor (10), the region inside the axial projection zone of the inside diameter of the flat coil is defined as a core zone (12),
stationary permanent magnet elements (14) arranged with rotational symmetry and having an alternating pole orientation in axial, radial or axial-radial direction form a magnet ring (13), magnet flux elements (21) are shaped as toothed elements (7),
the toothed elements, which are arranged with rotational symmetry and are separated from each other by toothed element gaps (8), form a soft-magnetic toothed element ring (6),
the number of the toothed elements (7) is identical to the number of the pole pairs of the magnet ring (13),
the toothed elements (7) and the permanent magnet elements (14) are uniformly distributed along the periphery,
the toothed element ring (6) is a component of the rotor (10),
at least one annular air gap (18) exists outside the core zone (12) between the magnet ring (13) and the toothed elements (7),
an annular air gap (17) disposed inside the core zone (12) is arranged axially between the rotor (10) and a stationary magnet flux element (21), and
the permanent magnet elements (14), the toothed elements (7) as well as additional magnetic flux elements (21) and at least two annular air gaps (17, 18) together form axially-radially oriented magnetic circuits (19), which extend axially-radially around the flat coil (11) through its coil center and surround the flat coil (11).

2. Electromechanical energy converter according to claim 1, characterized in
that a stationary soft-magnetic magnetic flux element (21) includes a bearing function for the rotor (10).

3. Electromechanical energy converter according to claim 2, characterized in
that a sliding layer (25) made from a hard material is disposed between the stationary soft-magnetic flux element (21) having the bearing function and the rotor (10).

4. Electromechanical energy converter according to claim 1, characterized in that the flat coil (11) comprises one or more single-plane helical coils, with a metal strip as a conducting material.

5. Electromechanical energy converter according to claim 1, characterized in that a common rotor (10) is used for two axially superimposed energy converters (29).

6. Electromechanical energy converter according to claim 1 characterized in that the geometric shape of the toothed elements (7) is designed for defining a preferred rotation direction of the energy converter (29).

7. Electromechanical energy converter according to claim 1, characterized in that the rotor (10) of the electromechanical energy converter (29) and the rotor (10) of an additional electromechanical energy converter (29) according to one of the preceding claims are coupled via a coupling gear wheel (30) or via a different forced coupling.

8. Electromechanical energy converter according to claim 1, characterized in that the toothed elements have a curved shape.
